(19) United States
(12) Patent Application Publication
(10) Pub. No.: US 2010/0020058 A1
(43) Pub. Date: Jan. 28, 2010

(54) Plasma display and driving method thereof

(76) Inventors: Jin-Ho Yang, Suwon-si (KR); Chul-Hong Kim, Suwon-si (KR); Tae-Kyeong Kweon, Suwon-si (KR); Ji-Hoon Kim, Suwon-si (KR); Joong-Yeol Kwon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/458,766

(22) Filed: Jul. 22, 2009

(30) Foreign Application Priority Data
Jul. 24, 2008 (KR) 10-2008-0072459

(51) Int. Cl. G09G 5/00

(52) U.S. Cl. 345/211; 345/60

(57) ABSTRACT

A plasma display including a first electrode and a second electrode formed in parallel is disclosed. The plasma display gradually decreases a voltage at the second electrode from a second voltage to a third voltage while a first voltage is applied to the first electrode during a reset period. The plasma display changes the first voltage according to a change in the discharge firing voltage between the first electrode and the second electrode. The change in the discharge firing voltage may be determined in accordance with an accumulated driving time or a discharge time during the reset period.

### BACKGROUND OF THE INVENTION

1. Field

Embodiments relate to a plasma display and a driving method thereof.

2. Description of the Related Art

A plasma display is a display device using a plasma display panel for displaying characters or images by using plasma generated by a gas discharge.

The plasma display device drives by dividing a frame into a plurality of subfields each having a weight value. A discharge cell (hereinafter referred to as a “cell”) is initialized by a reset discharge during a reset period of each subfield, and a light emitting cell and a non-light emitting cell are selected by address discharge during an address period of each subfield. The light emitting cell is sustain discharged during a sustain period of each subfield so that images are displayed

In the plasma display, a discharge firing voltage between two electrodes in the cell may decrease as accumulated driving time increases. Since a wall voltage between two electrodes of the non-light emitting cell increases when the discharge firing voltage decreases, misfiring in which discharge is generated in the non-light emitting cell may occur during the sustain period.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are directed to a plasma display and a driving method thereof, which substantially overcome one or more of the disadvantages of the related art.

It is a feature of an embodiment to provide a plasma display and a driving method thereof that prevent misfire generated when a discharge firing voltage is decreased.

At least one of the above and other features and advantages may be realized by providing a method of driving a plasma display including a first electrode and a second electrode, parallel to the first electrode, while dividing a frame into a plurality of subfields, the method including, in at least one subfield of the plurality of subfields, determining whether a discharge voltage between the first and second electrodes has decreased, gradually decreasing a voltage applied to the second electrode from a second voltage to a third voltage while a first voltage is applied to the first electrode during a reset period, and reducing a difference between the first voltage and the third voltage in accordance with a decrease in the discharge voltage.

Determining whether a discharge voltage between the first and second electrodes has decreased may include determining an accumulated driving time of the plasma display. Reducing the difference may include, when the accumulated driving time is greater than a predetermined driving time, setting the first voltage to a fourth voltage, lower than the first voltage.

When the accumulated driving time is less than or equal to the predetermined driving time, a light emitting cell and a non-light emitting cell may be selected while a fifth voltage is applied to the first electrode during an address period. When the accumulated driving time is greater than the predetermined driving time, a light emitting cell and a non-light emitting cell may be selected while a sixth voltage, lower than the fifth voltage, is applied to the first electrode during the address period. The first voltage may be equal to or less than the fifth voltage. The fourth voltage may be equal to or less than the sixth voltage.

The method may include gradually increasing a voltage at the second electrode from an eighth voltage to a ninth voltage while a seventh voltage is applied to the first electrode during the reset period of each subfield.

Determining whether a discharge voltage between the first and second electrodes has decreased may include determining whether a time of discharge between the first and second electrodes has increased.

Reducing the difference may include setting the first voltage to be a fourth voltage, less than the first voltage, when the time of discharge is earlier than a predetermined time. Determining the time of discharge may include sensing a current flowing through a switch configured to gradually decrease the voltage of the second electrode.

The method may include selecting a light emitting cell and a non-light emitting cell while a fifth voltage is applied to the first electrode during an address period, and reducing the fifth voltage when the time of discharge between the first and second electrodes has increased. The first voltage may be less than or equal to the fifth voltage.

At least one of the above and other features and advantages may be realized by providing a plasma display, including first and second electrodes extending in a direction, a first driver configured to apply a first voltage to the first electrode during a reset period, and a second driver configured to apply a voltage to the second electrode. The second driver may include a switch configured to decrease the voltage at the second electrode from a second voltage to a third voltage while the first voltage is applied to the first electrode during the reset period. A controller may be configured to change the first voltage in accordance with a current flowing in the switch.

The controller may be configured to reduce the first voltage when a period, from a point of time at which the switch is turned on to a point of time at which the current exceeds a predetermined magnitude, decreases.

The first driver may be configured to apply a fourth voltage to the first electrode during an address period. The second driver may be configured to apply a scan pulse for selecting a light emitting cell and a non-light emitting cell to the second electrode during the address period. The controller may be configured to change the fourth voltage in accordance with the current flowing in the switch. The fourth voltage may be greater than the first voltage.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plasma display according to an exemplary embodiment;

FIGS. 2 and 3 illustrate driving waveforms of the plasma display according to a first exemplary embodiment;

FIG. 4 illustrates a graph of discharge firing voltage between an X electrode and a Y electrode versus accumulated driving time;

FIG. 5 illustrates operation of a controller according to a first exemplary embodiment;

FIG. 6 illustrates a scan electrode driver according to an exemplary embodiment;

FIG. 7 illustrates a current flowing to a falling reset switch shown in FIG. 6;

FIG. 8 illustrates a drawing of an operation of a controller according to a second exemplary embodiment;

FIG. 9 illustrates a block diagram of a power supply according to an exemplary embodiment; and

FIG. 10 illustrates driving waveforms of the plasma display according to a second exemplary embodiment.

### DETAILED DESCRIPTION

Korean Patent Application No. 10-2008-0072459 filed, on Jul. 24, 2008, in the Korean Intellectual Property Office, and entitled, “Plasma Display and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Throughout the specification, if something is described to include constituent elements, it may further include other constituent elements unless it is described that it does not include other constituent elements.

Wall charges indicate charges formed on a wall of discharge cells neighboring each electrode and accumulated to electrodes. Although the wall charges do not actually touch the electrodes, it will be described that the wall charges are “generated,” “formed,” or “accumulated” thereon. Also, a wall voltage represents a potential difference formed on the wall of the discharge cells by the wall charges. A weak discharge is a discharge that is weaker than a sustain discharge in a sustain period and an address discharge in an address period.

The plasma display and a driving method thereof according to the exemplary embodiments will now be described in detail.

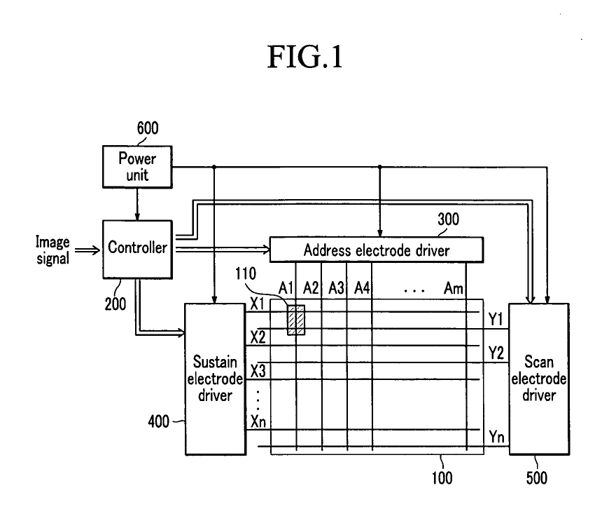

FIG. 1 illustrates a plasma display according to an exemplary embodiment. As shown in FIG. 1, the plasma display may include a plasma display panel 100, a controller 200, an address electrode driver 300, a sustain electrode driver 400, a scan electrode driver 500, and a power supply 600.

The plasma display panel 100 may include a plurality of address electrodes A1-Am (referred to as “A electrodes” hereinafter) extending in a column direction, and a plurality of sustain electrodes X1-Xn (referred to as “X electrodes” hereinafter) and a plurality of scan electrodes Y1-Yn (referred to as “Y electrodes” hereinafter) extending in a row direction, in pairs. In general, the X electrodes X1-Xn are formed to correspond to the respective Y electrodes Y1-Yn, and the X electrodes X1-Xn and the Y electrodes Y1-Yn perform a display operation during a sustain period in order to display an image.

The Y electrodes Y1-Yn and the X electrodes X1-Xn are disposed to cross the A electrodes A1-Am. A discharge space at each crossing area of the A electrodes A1-Am and the X and Y electrodes X1-Xn and Y1-Yn forms discharge cells 110. The structure of the PDP 100 is just one example, and panel with different structures to which driving waveforms described herein may be applied may also be applicable to embodiments.

The controller 200 may receive an image signal from the outside and may output an A electrode driving control signal, an X electrode driving control signal, and a Y electrode driving control signal. Further, the controller 200 may divide a frame into a plurality of subfields, each subfield having a weight value. The controller 200 may set a voltage difference between the X electrodes X1-Xn and Y the electrodes Y1-Yn to decrease as a discharge firing voltage between the X electrodes X1-Xn and Y the electrodes Y1-Yn decreases. In particular, the controller 200 may control a voltage applied to the X electrodes X1-Xn in a falling period of a reset period to decrease as the discharge firing voltage between the X electrodes X1-Xn and Y the electrodes Y1-Yn decreases.

The address electrode driver 300 may receive the A electrode driving control signal from the controller 200 and may apply a driving voltage to the A electrodes A1-Am. The sustain electrode driver 400 may receive the X electrode driving control signal from the controller 200 and may apply a driving voltage to the X electrodes X1-Xn. The scan electrode driver 500 may receive the Y electrode driving control signal from the controller 200 and may apply a driving voltage to the Y electrodes Y1-Yn.

The power supply 600 may supply power for driving the plasma display device to the controller 200 and the respective drivers 300, 400, and 500. In this instance, the power supply 600 may vary a driving voltage for driving the plasma display according to the driving control signal from the controller 200 and may supply varied driving voltages to the drivers 300, 400, and 500.

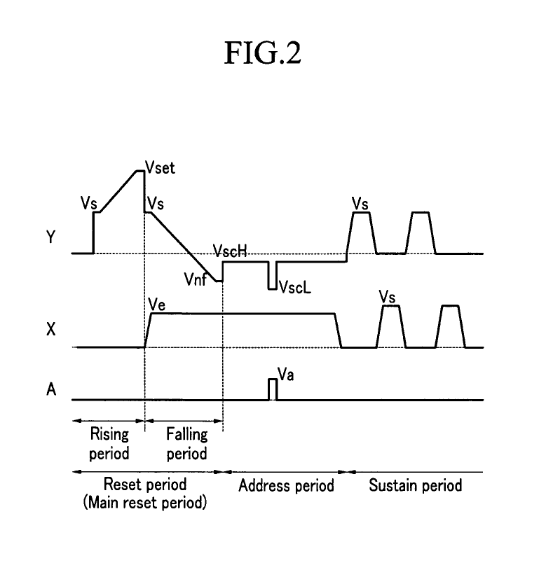

A driving waveform when the discharge firing voltage between the X electrodes X1-Xn and the Y electrodes Y1-Yn is Vfxy1 and a driving waveform when the discharge firing voltage between the X electrodes X1-Xn and the Y electrodes Y1-Yn is Vfxy2 that is lower than Vfxy1 will be described in detail with reference to FIGS. 2 and 3.

FIGS. 2 and 3 illustrate driving waveforms of the plasma display according to first exemplary embodiment. FIGS. 2 and 3 illustrate driving waveforms when the discharge firing voltage between the X electrodes X1-Xn and the Y electrodes Y1-Yn are Vfxy1 and Vfxy2, respectively, where Vfxy2 is less than Vfxy1. In FIGS. 2 and 3, the driving waveforms will be described with reference to a cell formed by an A electrode, an X electrode, and a Y electrode.

As shown in FIGS. 2 and 3, during a rising period of the reset period, the address electrode driver 300 and the sustain electrode driver 400 may bias the A and X electrodes to a reference voltage (0V in FIGS. 2 and 3), respectively, and the scan electrode driver 500 may gradually increase the voltage of the Y electrodes from a voltage Vs to a voltage Vset. In FIGS. 2 and 3, the voltage of the Y electrodes increases in a ramp pattern. Then, while the voltage of the Y electrodes is increasing, a weak discharge occurs between the Y and X electrodes and between Y and A electrodes, forming negative (−) wall charges in the Y electrodes and positive (+) wall charges in the X and A electrodes. The Vset voltage may be set to be larger than the discharge firing voltage Vfxy1 between the X electrode and the Y electrode in order to induce discharge at all cells.

Subsequently, in a falling period of the reset period in FIG. 2, the sustain electrode driver 400 may bias the X electrode with a voltage Ve, and the scan electrode driver 500 may gradually decrease the voltage of the Y electrode from the voltage Vs to a voltage Vnf. In FIGS. 2 and 3, the voltage of the Y electrodes decreases in a ramp pattern. Then, while the voltage of the Y electrodes is decreasing, a weak discharge occurs between the Y and X electrodes and between the Y and A electrodes, erasing the negative (−) wall charges formed in the Y electrodes and the positive (+) wall charges formed in the X and A electrodes. In general, the voltage Ve and the voltage Vnf may be set so that the wall voltage between the Y electrode and the X electrode is near 0V in order to prevent a misfiring discharge in a non-light emitting cell. That is, a voltage (Ve−Vnf) may be set to be close to the discharge firing voltage Vfxy1 between the Y electrode and the X electrode.

In the address period, in order to select a light emitting cell, the sustain electrode driver 400 may maintain the voltage of the X electrode at the voltage Ve, and the scan electrode driver 500 and the address electrode driver 300 may apply a scan pulse having a voltage VscL and an address pulse having a voltage Va to the Y electrode and the A electrode, respectively. The scan electrode driver 400 may apply a non-selected Y electrode with the voltage VscH, higher than the voltage VscL. The address electrode driver 300 may apply the A electrode of a non-light emitting cell with the reference voltage. At this time, the voltage VscL may be equal to or less than the voltage Vnf.

In detail, in the address period, the scan electrode driver 500 and the address electrode driver 300 may apply scan pulses to the Y electrode (Y1 in FIG. 1) of a first row and, at the same time, may apply address pulses to the A electrodes positioned at light emitting cells in the first row. Then, address discharges occur between the Y electrodes (Y1 in FIG. 1) of the first row and the A electrodes to which the address pulses have been applied, forming positive (+) wall charges in the Y electrode (Y1 in FIG. 1) and negative (−) wall charges in the A and X electrodes. Subsequently, while the scan electrode driver 500 applies scan pulses to the Y electrode (Y2 in FIG. 1) of a second row, the address electrode driver 300 may apply address pulses to the A electrodes positioned at light emitting cells of the second row.

Then, address discharges occur at cells formed by the A electrodes to which the address pulses have been applied and the Y electrode (Y2 in FIG. 1) of the second row, forming wall charges in the cells. Likewise, while the scan electrode driver 500 sequentially applies scan pulses to the Y electrodes of the remaining rows, the address electrode driver 300 may apply address pulses to the A electrodes positioned at light emitting cells to form wall charges.

In the sustain period, the scan electrode driver 500 may apply the sustain pulse alternately having a high level voltage (Vs in FIG. 2) and a low level voltage (0V in FIG. 2) to the Y electrodes a number of times corresponding to a weight value of the corresponding subfield. In addition, the sustain electrode driver 400 may apply a sustain pulse to the X electrodes in a phase opposite to that of the sustain pulse applied to the Y electrodes. For example, 0V may be applied to the X electrode when the voltage Vs is applied to the Y electrode and the voltage Vs may be applied to the X electrode when 0V is applied to the Y electrode.

In this case, the voltage difference between the Y electrode and the X electrode alternately may alternate between a Vs voltage and a −Vs voltage. Accordingly, the sustain discharge repeatedly occurs at light emitting cells as many times as the predetermined number.

When the discharge firing voltage between the X electrode and the Y electrode decreases to Vfxy2, a predetermined wall voltage between the X electrode and the Y electrode may be formed by the (Ve−Vnf) voltage, i.e., the (Ve−Vnf) voltage may exceed the discharge firing voltage Vfxy2. Thus, a misfire in the cell may occur.

As shown in FIG. 3, when the discharge firing voltage between the X electrode and the Y electrode becomes Vfxy2, the sustain electrode driver 400 may apply a voltage Ve′, lower than the voltage Ve, during the falling period of the reset period and during the address period. Then, since a voltage difference (Ve′−Vnf) between the X electrode and the Y electrode is decreased as the discharge firing voltage between the X electrode and the Y electrode is decreased, misfiring in the cell may not occur. The waveforms applied to the Y electrode and the A electrode may be the same as in FIG. 2.

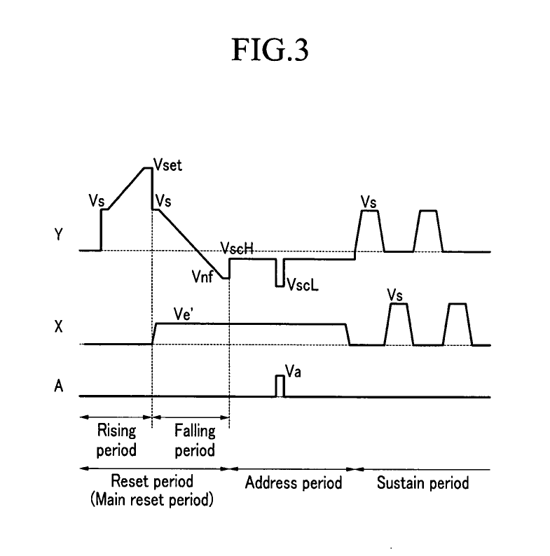

Next, a method for changing the voltage applied to the X electrode in the falling period of the reset period and the address period according to the discharge firing voltage between the X electrode and the Y electrode will be described in detail with reference to FIGS. 4 to 8.

FIG. 4 illustrates a discharge firing voltage between the X electrode and the Y electrode versus accumulated driving time. In particular, FIG. 4 shows a result of a measured discharge firing voltage Vfxy between the X electrode and the Y electrode at 100 hours in a full-white screen. Further, C1 to C6 respectively denote different positions of discharge cells 110 in the plasma display panel 100 shown FIG. 1.

As shown in FIG. 4, the discharge firing voltage between the X electrode and the Y electrode decreases as the accumulated driving time of the plasma display increases. That is, a change of the discharge firing voltage between the X electrode and the Y electrode may be perceived based on the accumulated driving time of the plasma display.

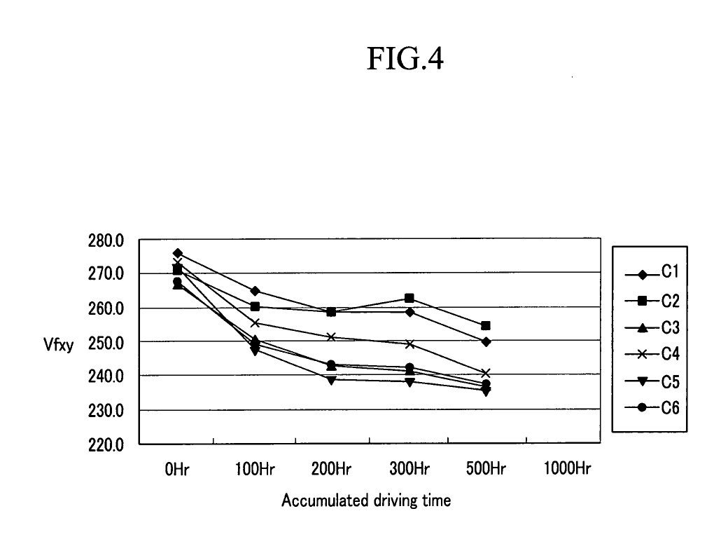

FIG. 5 illustrates an operation of the controller 200 according to a first exemplary embodiment. In the operation of FIG. 5, a decrease in the discharge firing voltage is assumed to be due to the accumulated driving time.

As shown in FIG. 5, the controller 200 may count the accumulated driving time of the plasma display in operation S510. The controller 200 may compare the accumulated driving time of the plasma display with a predetermined time in operation S520. When the accumulated driving time is less than the predetermined time, the controller 200 may output a driving control signal in which the voltage Ve is applied to the X electrode to the sustain electrode driver 400 in operation S530. On the other hand, when the accumulated driving time exceeds the predetermined, time the controller 200 may output a driving control signal in which the voltage Ve′ that is lower than the voltage Ve is applied to the X electrode to the sustain electrode driver 400 in operation S540.

Then, the sustain electrode driver 400 may apply the voltage Ve or the voltage Ve′ in the falling period of the reset period and address period according to the driving control signal output from the controller 200.

Further, a discharge may be quickly generated between the X electrode and the Y electrode when the discharge firing voltage between the X electrode and the Y electrode decreases, and a discharge may be slowly generated between the X electrode and the Y electrode when the discharge firing voltage between the X electrode and the Y electrode increases. That is, a change in the discharge firing voltage between X electrode and Y electrode may also be perceived with respect to a point of time in which the discharge occurs. In particular, as the discharge firing voltage between the X electrode and the Y electrode decreases, a time at which discharge occurs becomes earlier.

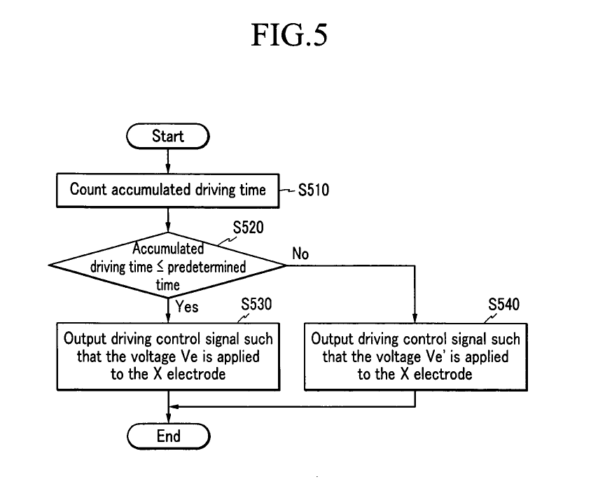

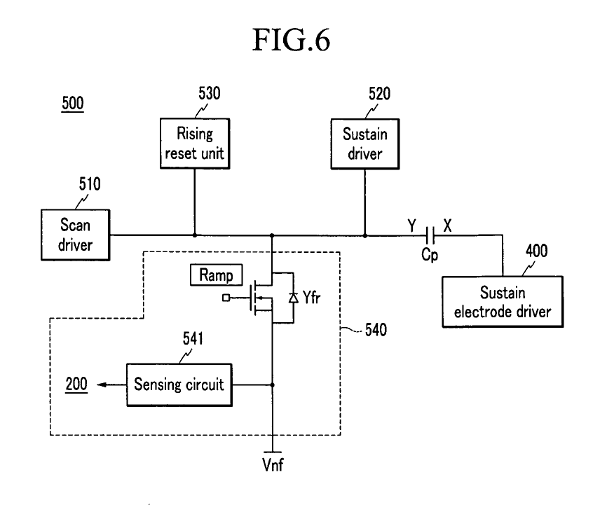

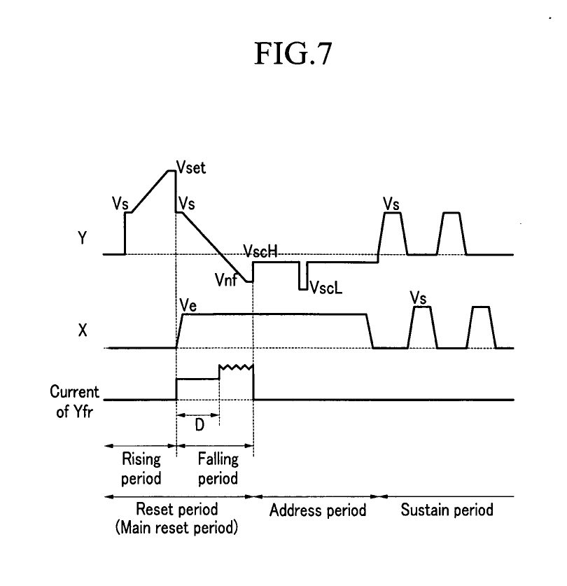

FIG. 6 illustrates the scan electrode driver 500 according to an exemplary embodiment. FIG. 7 illustrates a current flowing to a falling reset switch shown in FIG. 6. FIG. 8 illustrates an operation of the controller 200 according to a second exemplary embodiment.

FIG. 6 illustrates only a single Y electrode for better understanding and ease of description, and a capacitive component formed by the single Y electrode and a single X electrode is shown as a panel capacitor Cp. As shown in FIG. 6, the scan electrode driver 500 may include a scan driver 510, a sustain driver 520, a rising reset unit 530, and a falling reset unit 540.

The scan driver 510 is connected to the Y electrode. During the address period, the scan driver 510 may apply the voltage VscL to the Y electrode of the light emitting cell and the voltage VscH to the Y electrode of the non-light emitting cell. The sustain driver 520 is connected to the Y electrode. During the sustain period, the sustain driver 520 may apply the sustain pulse alternately having the voltage Va and the voltage 0V during the sustain period. The rising reset unit 530 is connected to the Y electrode, and may gradually increase the voltage of the Y electrode during the rising period of the reset period.

The falling reset unit 540 may include a falling reset switch Yfr and sensing circuit 541. The falling reset switch Yfr may be connected between a power source Vnf for supplying the voltage Vnf and the Y electrode. When the falling reset switch Yfr is turned on, a small current flows from its drain to its source to gradually decrease the voltage at the Y electrode to the voltage Vnf. Such a falling reset unit 540 may gradually decrease the voltage at the Y electrode to the voltage Vnf as the falling reset switch Yfr is repeatedly turned on and off. The sensing circuit 541 may sense a current flowing to the falling reset switch Yfr and may transmit the sensed current to the controller 200.

As shown in FIG. 7, when the falling reset switch Yfr is turned on in the falling period of the reset period, a current of a predetermined magnitude flows to the falling reset switch Yfr. When a discharge between the X electrode and Y electrode occurs while the voltage of the Y electrodes decreases, an additional current due to the discharge flows to the falling reset switch Yfr. Thus, when the sensing circuit 541 transmits the current flowing to the falling reset switch Yfr to the controller 200, the controller 200 may measure a period D from a point of time at which the falling reset switch Yfr is turned on to a point of time at which the additional current begins to flow to the falling reset switch Yfr. Thus, a point of time at which the discharge occurs may be perceived through the period D. This period D will decrease as the discharge firing voltage decreases, i.e., as the time at which discharge occurs becomes earlier.

As shown in FIG. 8, the controller 200 may calculate the period D in operation S810 and may determine a change of the voltage applied to the X electrode corresponding to the discharge firing voltage Vfxy in the falling period of the reset period and the address period using correlation data between the period D and the discharge firing voltage Vfxy in operation S820. The controller 200 may output the driving control signal corresponding to the change of the voltage applied to the X electrode in the falling period of the reset period and the address period to the sustain electrode driver 400 in operation S830.

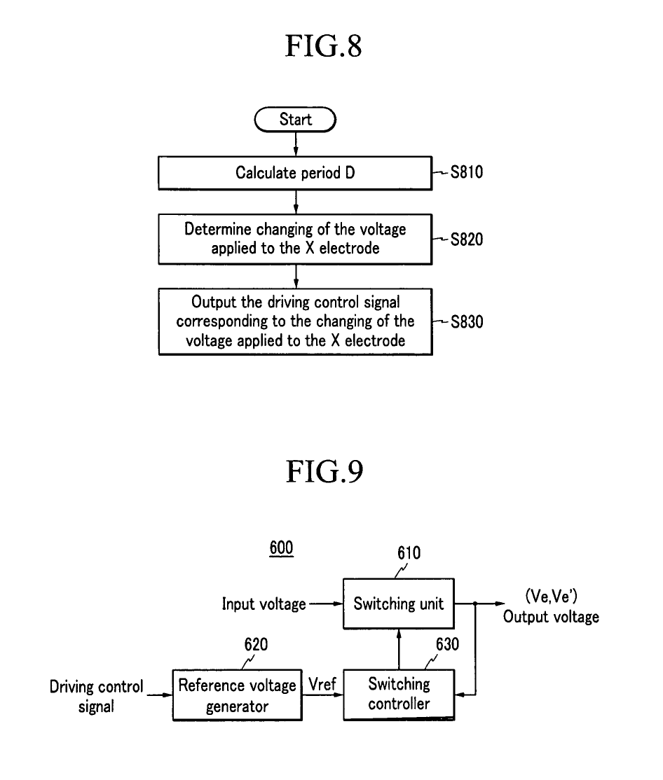

In this case, when the voltage is applied to the X electrode in the falling period of the reset period and the address period according to the discharge firing voltage Vfxy, the plasma display needs an additional power source according to the change of the voltage. An exemplary embodiment for applying different levels of voltages with a single power source will now be described in detail with reference to FIG. 9.

FIG. 9 illustrates a block diagram of the power unit 600 according to an exemplary embodiment. As shown in FIG. 9, the power unit 600 may include a switching unit 610, a reference voltage generator 620, and a switching controller 630.

The switching unit 610 may convert an input voltage to an output voltage (i.e., Ve) using a switch (not shown) for switching according to a duty ratio and may output the output voltage. The reference voltage generator 620 may change the reference voltage Vref according to the driving control signal output to the sustain electrode driver 400 by the controller 200. The switching controller 630 may determine a duty ratio of the switch according to the reference voltage Vref and the output voltage. At this time, the output voltage may be changed to a voltage (i.e., Ve′) different from the voltage Ve according to the duty ratio of the switch.

Meanwhile, FIGS. 2 and 3 illustrate that the reset period forms a main reset period in which the reset discharge is generated in all the cells, in order to reduce background luminance, the reset period of at least one subfield among the plurality of subfields may form a sub-reset period in which the reset discharge is only generated in the cells having undergone the sustain discharge in the previous subfield. The sub-reset period may include only the falling period, or may include the rising period and the falling period. When the sub-reset period includes the rising period and the falling period, the voltage of the Y electrode in the rising period may gradually increase a voltage that is lower than the voltage Vset shown in FIGS. 2 and 3.

In this case, a driving waveform in the sub-reset period may also be applicable in embodiments. Further, the voltage applied to the X electrode in the falling period of the reset period and the address period may be different, in contrast to the driving waveforms in FIGS. 2 and 3.

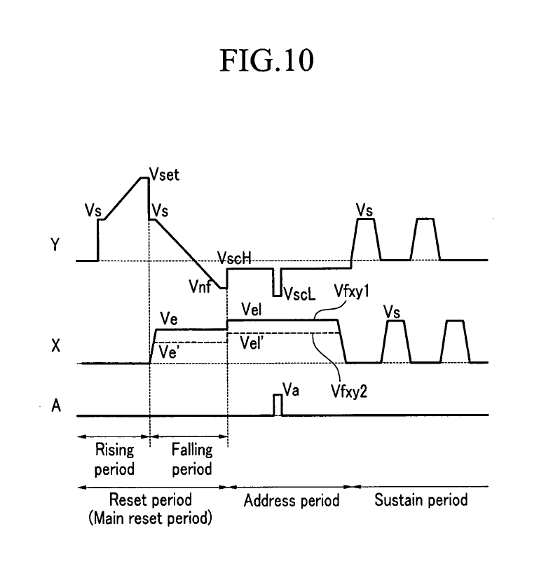

FIG. 10 illustrates a driving waveform of the plasma display according to a second exemplary embodiment of the present invention.

As shown in FIG. 10, in the address period, the sustain electrode driver 400 may apply a voltage that is higher than a voltage applied to the X electrode during the falling period of the reset period. Then, since the voltage difference between the X electrode and the Y electrode increases in the address period, sufficient wall charges may be formed on the X electrode and the Y electrode. Accordingly, the sustain discharge between the X electrode and the Y electrode may occur stably during the sustain period.

In detail, the sustain electrode driver 400 may apply the voltage Ve to the X electrode during the falling period of the reset period and a voltage Ve1, higher than the voltage Ve, to the X electrode during the address period when the discharge firing voltage between the X electrode and the Y electrode is Vfxy1. When the discharge firing voltage between the X electrode and the Y electrode decreases to Vfxy2, the sustain electrode driver 400 may apply the voltage Ve′ to the X electrode during the falling period of the reset period and a voltage Ve1′, higher than the voltage Ve′, to the X electrode during the address period.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving a plasma display including a first electrode and a second electrode, parallel to the first electrode, while dividing a frame into a plurality of subfields, the method comprising, in at least one subfield of the plurality of subfields:
determining whether a discharge voltage between the first and second electrodes has decreased;
gradually decreasing a voltage applied to the second electrode from a second voltage to a third voltage while a first voltage is applied to the first electrode during a reset period; and
reducing a difference between the first voltage and the third voltage in accordance with a decrease in the discharge voltage.

2. The method as claimed in claim 1, wherein determining whether a discharge voltage between the first and second electrodes has decreased includes determining an accumulated driving time of the plasma display.

3. The method as claimed in claim 2, wherein reducing the difference includes, when the accumulated driving time is greater than a predetermined driving time, setting the first voltage to a fourth voltage, lower than the first voltage.

4. The method as claimed in claim 3, further comprising:
when the accumulated driving time is less than or equal to the predetermined driving time, selecting a light emitting cell and a non-light emitting cell while a fifth voltage is applied to the first electrode during an address period; and
when the accumulated driving time is greater than the predetermined driving time, selecting a light emitting cell and a non-light emitting cell while a sixth voltage, lower than the fifth voltage, is applied to the first electrode during the address period.

5. The method as claimed in claim 4, wherein the first voltage is equal to the fifth voltage.

6. The method as claimed in claim 4, wherein the first voltage is lower than the fifth voltage.

7. The method as claimed in claim 4, wherein the fourth voltage is equal to the sixth voltage.

8. The method as claimed in claim 4, wherein the fourth voltage is lower than the sixth voltage.

9. The method as claimed in claim 1, further comprising gradually increasing a voltage at the second electrode from an eighth voltage to a ninth voltage while a seventh voltage is applied to the first electrode during the reset period of each subfield.

10. The method as claimed in claim 1, wherein determining whether a discharge voltage between the first and second electrodes has decreased includes determining whether a time of discharge between the first and second electrodes has increased.

11. The method as claimed in claim 10, wherein reducing the difference includes setting the first voltage to be a fourth voltage, less than the first voltage, when the time of discharge is earlier than a predetermined time.

12. The method as claimed in claim 10, wherein determining the time of discharge includes sensing a current flowing through a switch configured to gradually decrease the voltage of the second electrode.

13. The method as claimed in claim 10, further comprising:
selecting a light emitting cell and a non-light emitting cell while a fifth voltage is applied to the first electrode during an address period; and
reducing the fifth voltage when the time of discharge between the first and second electrodes has increased.

14. The method as claimed in claim 13, wherein the first voltage is equal to the fifth voltage.

15. The method as claimed in claim 13, wherein the first voltage is lower than the fifth voltage.

16. A plasma display, comprising:
first and second electrodes extending in a direction;
a first driver configured to apply a first voltage to the first electrode during a reset period;
a second driver configured to apply a voltage to the second electrode, the second driver including a switch configured to decrease the voltage at the second electrode from a second voltage to a third voltage while the first voltage is applied to the first electrode during the reset period; and
a controller configured to change the first voltage in accordance with a current flowing in the switch.

17. The plasma display as claimed in claim 16, wherein the controller is configured to reduce the first voltage when a period, from a point of time at which the switch is turned on to a point of time at which the current exceeds a predetermined magnitude, decreases.

18. The plasma display as claimed in claim 17, wherein the first driver is configured to apply a fourth voltage to the first electrode during an address period, and the second driver is configured to apply a scan pulse for selecting a light emitting cell and a non-light emitting cell to the second electrode during the address period.

19. The plasma display as claimed in claim 18, wherein the controller is configured to change the fourth voltage in accordance with the current flowing in the switch.

20. The plasma display as claimed in claim 18, wherein the fourth voltage is greater than the first voltage.
